(19) United States
(12) Patent Application Publication
(10) Pub. No.: US 2008/0134764 A1
(43) Pub. Date: Jun. 12, 2008

(54) Apparatus And Method For Providing A Test Tee

(76) Inventor: Tony L. Brock, Ashbill, NC (US)

Correspondence Address: CANTOR COLBURN, LLP, 20 Church Street, 22nd Floor, Hartford, CT, 06103, US

(21) Appl. No.: 11/933,123

(22) Filed: Oct. 31, 2007

Related U.S. Application Data
(63) Continuation-in-part of application No. 11/201,769, filed on Aug. 11, 2005, now abandoned.

(51) Int. Cl. G01M 3/04

(52) U.S. Cl. 73/49.8

(57) ABSTRACT

The present invention provides a test tee device for leak testing a pipe line system. In structure, the tee test device comprising a tee fitting. The tee fitting comprises a tubular section with first and a second opposing openings, a third opening with the tubular section of the tee fitting, and a removable insert attached in the tubular section and blocking the flow through said first opening. The tubular section has an inside diameter greater than the inside diameter of the first and of the second opening, and the removable insert is larger than the inside diameter of said tubular section. The tubular section also contains a notched section to allow for movement of the pull tab portion of the removable insert. The present invention also provides for a test tee device wherein the removable insert comprises a threaded blockage device.

### CROSS-REFERENCE TO RELATED APPLICATIONS

This application is a continuation-in-part of copending U.S. application entitled, “Apparatus And Method For Providing A Test Tee”, having Ser. No. 11/210,769, filed Aug. 11, 2005 and provisional application Ser. No. 60/600,830, filed on Aug. 11, 2004, entitled “1½″, 2″, 3″ and 4″ Street Test Tee with Pop-Top”, U.S. Provisional Patent Application Ser. No. 60/682,789, filed on May 19, 2005, entitled “1½″, 2″, 3″ and 4″ Street Test Tee with Pop-Top” and U.S. Provisional Patent Application Ser. No. 60/695,240, filed on Jun. 29, 2005, entitled “Tru Test Tee Description”, all of which are incorporated by reference herein in their entirety.

### TECHNICAL FIELD

The present invention relates to an apparatus and method for providing a test tee, and more particularly, relates to an apparatus and method for testing of newly installed plumbing waste and vent systems that are above and/or below ground.

### BACKGROUND OF THE INVENTION

Currently in the United States, testing of new plumbing systems is required by plumbing codes to insure that there are no leaks, bad fittings, bad connections, cracked pipes, etc. The waste and vent system is tested by filling the pipes with water or air. These tests require 5 lbs, or greater PSI (per square inch) of air or 10 feet of head pressure for water. The system must hold this pressure for the length of time determined by local authorities. For example, in Georgia this length of time is approximately 15 minutes.

Test tees are currently installed in plumbing systems where new pipes meet with the existing or previously inspected systems, such as an underground system tied into a city tap. The test tee would be installed between the end of the city tap and the beginning of the new system, This would allow a plug to be placed in the new system side of the tee so the system can be tested. The tee is most often used when the previously inspected underground waste system comes through a concrete slab. It would be connected between the pipes penetrating the slab and the continuation of the above ground system. This would allow a test to be administered from this point and above without retesting the underground system.

The tee fitting is sometimes referred to as a cleanout tee. It is simply a T shaped fitting with a threaded opening for a removable plug. Tee fittings comprise a tubular section extending between a first and a second opposing openings axially aligned with each other; and a third opening communicating with the tubular section of the tee fitting.

When the tee fitting is used in the testing application the plug is removed and a rubber inflatable ball or mechanical compression plug is inserted into the tee on the new side to create a blockage to the waste and vent system so it can be filled with air or water for testing. Once all testing has been completed and the system is functional the threaded plug may be removed, when accessible, and the opening maybe used to cleanout any possible blockage below this point in the future,

The problem that often exists with this process is that these rubber test balls sometimes do not hold applied air or water pressure dropping below the code requirement. Improper installation or positioning will not allow for a secure seal and often causes the test to lose pressure. The inflatable test bails are made of natural rubber and have a limited life expectancy causing failure and replacement can be costly. Mechanical plugs have been known to fail if not properly installed and in some instances can crack pipes or fittings.

To find any of these problems in a large system that is being prepared for inspection can be very time consuming especially when testing with air. The failing test device is not always immediately recognizable. Once the problem is located the ball must be reinstalled and re-inflated. If the ball appears faulty, a new ball must be utilized and the system completely retested. This process is very intensive and could be the cause for a failed inspection potentially delaying a project schedule,

Therefore, there is a tremendous need for a true test tee that is sure hold pressure for the length of time determined by local authorities to complete testing of a plumbing system.

### SUMMARY OF THE INVENTION

The present invention provides for apparatus and method for providing a test tee, and more particularly, relates to a apparatus and method for testing of newly installed plumbing waste and vent systems that are above and/or below ground

The present invention provides a test tee device for leak testing a pipe line system, and more particularly, relates to a apparatus and method for testing of newly installed plumbing waste and vent systems that are above, at, and/or below ground. In structure, the tee test device comprising a tee fitting. The tee fitting comprises a tubular section with first and a second opposing openings, a third opening with the tubular section of the tee fitting, and a removable insert attached in the tubular section and blocking the flow through said first opening. The tubular section has an inside diameter greater than the inside diameter of the first and of the second opening, and the removable insert is larger than the inside diameter of said tubular section. The tubular section also contains a notched section to allow for movement of the pull tab portion of the removable insert.

The present invention can also be viewed as a method for leak testing a pipe line system. The method operates by first inserting a test tee fitting, which includes first and a second opposing openings, a third opening with the tubular section of the tee fitting, a removable insert attached in the tubular section and blocking the flow through said first opening, and a notched section of the tubular section. The tubular section has an inside diameter greater than the inside diameter of the first and of the second opening, and the removable insert is larger than the inside diameter of said tubular section. Test pressure is applied to the test tee fitting through either of the opposing openings. If the pressure is maintained for a predetermined time, the pull-tab can be engaged to move a portion of the removable insert into the notched section of the tubular section, thereby allowing for removal of the entire removable insert.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1A is a perspective view of a tee fitting of the prior art.

FIG. 1B is a cross-sectional side view of a tee fitting of the prior art.

FIG. 1C is a bottom view of a tee fitting of the prior art.

FIG. 2A is a perspective view illustrating an example of the test tee of the present invention.

FIG. 2B is a bottom view illustrating an example of the test tee of the present invention with the pull-tab pop-top.

FIG. 3A is a cross-sectional side view illustrating an example of the test tee of the present invention, with the pull-tab pop-top as shown in FIG. 2B.

FIG. 3B is a cross-sectional side view illustrating an example of part of the pop top as attached to the test tee of the present invention, as shown in FIGS. 2B and 3A.

FIG. 3C is another cross-sectional side view illustrating an example of part of the pop top as attached to the test tee of the present invention, as shown in FIGS. 2B and 3A.

FIG. 4 is a cross-sectional side view illustrating an example of an alternative embodiment of the pop top hub containing the pop top before it is attached to the test tee of the present invention.

FIG. 5A is a cross-sectional side view illustrating an example of an alternative embodiment of the pull-tab pop top of the present invention, with the prior art tee.

FIG. 5B is a top view illustrating an example of an alternative embodiment of the pull-tab pop top of the present invention.

FIG. 5C is a bottom view illustrating an example of an alternative embodiment of the pull-tab pop top of the present invention.

FIG. 6A is a cross-sectional side view illustrating an example of an alternative embodiment of the pull tab pop top, with the test tee of the present invention.

FIG. 6B is a top view illustrating an example of an alternative embodiment of the pull tab pop top hub.

FIG. 6C is a bottom view illustrating an example of an alternative embodiment of the pull tab pop top hub.

FIG. 7A is a cross-sectional side view illustrating an example of an alternative embodiment of the hub to hub test tee with of the present invention, with internal threads on one of the opposing openings that are axially aligned with each other.

FIG. 7B is a cross-sectional side view illustrating an example of an alternative embodiment of the hub to street test tee with of the present invention, with internal threads on one of the opposing openings that are axially aligned with each other.

FIG. 7C is a cross-sectional side view illustrating an example of an alternative embodiment of the street to street test tee with of the present invention, with internal threads on both of the opposing openings that are axially aligned with each other.

FIG. 7D is a cross-sectional side view illustrating an example of an alternative embodiment of the removable threaded blockage device for a test tee of the present invention.

FIG. 7E is a bottom view illustrating an example of an alternative embodiment of the removable threaded blockage device for a test tee of the present invention.

### DETAILED DESCRIPTION OF THE PREFERRED EMBODIMENTS

The present invention relates to an apparatus and method for providing a test tee. In particular, relates to an apparatus and method for testing of newly installed plumbing waste and vent systems that are above and/or below ground. Typically these plumbing waste and vent systems utilize 1½″, 2″, 3″ and 4″ diameter pipes. However, the invention techniques described herein apply to plumbing piping of all sizes for commercial and residential uses.

The test tee of the present invention utilizes a pull-tab pop top to create blockage for testing purposes. In the one embodiment, the pop top is a metallic pop top that is very similar to that of tennis ball or dog food cans. The pull ring is of a size and shape typically found in rings associated with soda cans or tennis ball cans and usually is adapted to receive a finger, most likely the index finger.

The seal for the pop top can be formed preferably by a scribe cut in the surface of the barrier material. It may be desirable to deepen the scribe cut near the pull-tab to insure that only this portion of the seal is broken away initially, so that water and/or air flows through this break rather than gushes through a larger separation which might otherwise accidentally occur. The scribe cut should not so weaken the pop top material as to cause it to yield under pressure normally associated with pressure testing. It should be deep enough, however, to allow relatively easy removal of the removable portion of the pop top with ordinary manual force. Presently preferred materials for seal include, but are not limited to, aluminum, tin, plastic, rubber and any malleable metal. In another embodiment, the seal may be designed to “crumble” rather than tear away.

In one embodiment, the pop top is molded into the test tee of the present invention in an angle perpendicular to the flow to create blockage on the newly installed side of the system. This eliminates the need for installation of any other testing equipment. The elimination of other testing equipment reduces cost of material and labor as well as potential retesting costs due to a failure.

In an alternative embodiment, the test tee of the present invention utilizes a removable threaded blockage device to create blockage for test purposes in the test tee. The removable threaded blockage device includes a threaded collar for engaging the internal threads of either or both of the internal first and second opposing openings that are axially aligned with each other in the test tee.

In any embodiment, the tubular section has an inside diameter greater than the inside diameter of the first and of the second opening, and the removable insert is larger than the inside diameter of said tubular section in order to be in compliance with International plumbing code section 706.2 on obstructions. This code section requires that “the fittings shall not have ledges, shoulders, or reductions, capable of retarding or obstructing flow in the piping. Threaded type fittings shall be of the recessed drainage type.” The International Association of Plumbing and Mechanical Officials (IAPMO) is the certification board that certified a test tee of the present invention having a threaded socket for an external plug as an access opening with a removable metal top at the inlet. This product complies with the applicable sections of the latest edition of the Uniform Plumbing Code and is in compliance with IGC 224-05.

In particular, the test tee of the present invention may be utilized in either a street by street fitting, which means that both ends of the fitting are the same outside dimension of the pipe being used, or a hub by hub fitting, which means a pipe would fit inside the hub of the tee itself. In one embodiment, the test tee is a street by street fitting that can be applied to different material waste and vent systems piping such as but not limited to, copper, cast iron, galvanized pipe, ABS or any other type of piping that can be used with the proper mechanical couplings.

The testing of a plumbing waste or vent system utilizing the test tee of the present invention requires that the threaded plug (not shown) be removed. At that time, a test plug (not shown), which is well-known in the art, is attached to the test tee of the present invention. One type of test plug is illustrated in U.S. Pat. No. 6,912,890 B1. However, it is well-known that there are many types of apparatus used to create a blockade in a test tee to test the plumbing system. The plumbing waste or vent system is then pressurized to verify that the system maintained the air or water pressure without dropping below code requirement. Because the pop top test tee of the present invention virtually eliminates the possibility failure of the test tee, the inspection can be performed without the need for retesting due to equipment failure.

Once the test is complete and the inspections have occurred, the metal pop-top is simply detached, as by the pull-tab. The pull-tab, when engaged, presses a portion of the pop top into a notched section of the tubular section, and allows for detachment of the pop top. The pop top can then be pulled through the threaded opening for disposal. Because the diameter of the pop top is larger than the inside diameter of the pop top hub, the removal of the pop top leaves a clean, smooth finish on the inside of the tee and allow the test tee to remain in the system, and fluid flow through the pipe and fitting system will be substantially unobstructed. The threaded plug can now be reinstalled and the test tee can become a cleanout tee if accessible and so desired. Subsequent sections can then be installed and tested.

The present invention also relates to a method for manufacturing a test tee. The method includes molding a test tee fitting, wherein the tee fitting comprises a tubular section extending between a first and a second opposing openings axially aligned with each other and a third opening communicating with the tubular section of the tee fitting. A removable insert is attached into the tubular section perpendicular to said first opening in order to block the flow through the first opening. The diameter of the removable insert is larger than the inside diameter of said tubular section, and is anchored to the tubular section.

In the preferred embodiment, the tubular section is designed with a notched section above the removable inserts pull tab. This is done in order to provide a space for the pull ring to deflect into the notch to penetrate the breakpoint, (i.e. scribe cut) when a user attempts to remove the removable insert. Without the notched section, removal of the removable insert would be very difficult.

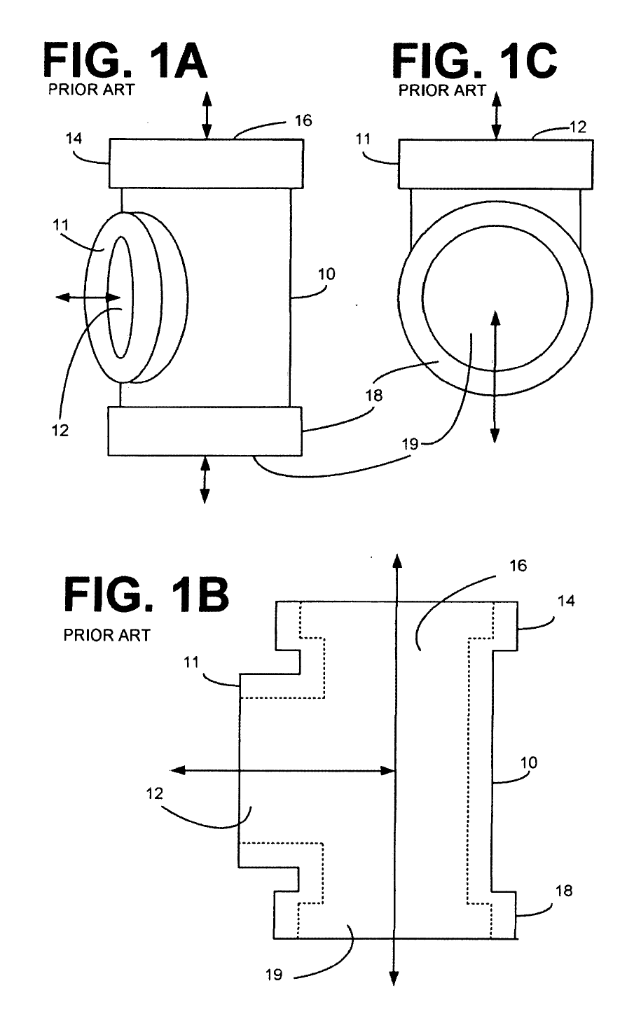

Referring now to the drawings, in which like numerals illustrate like elements throughout the several views, FIG. 1 (A-C) illustrates an example of the basic components of a tee fitting of the prior art. Shown is a test tee 10 of the prior art, which is sometimes referred to as a cleanout tee. It is simply a T-shaped fitting with a threaded opening 12 for a removable plug (not shown). Test tee 10 has hub fittings (i.e. connectors) 14 and 18 which correspond to openings 16 and 19, respectively. Test tee 10 also includes the clean out or testing open hub 11 that enables testing equipment or drain cleaning equipment to be inserted through the threaded opening 12. The threaded opening 12 connects openings 16 and 19 in the test tee 10.

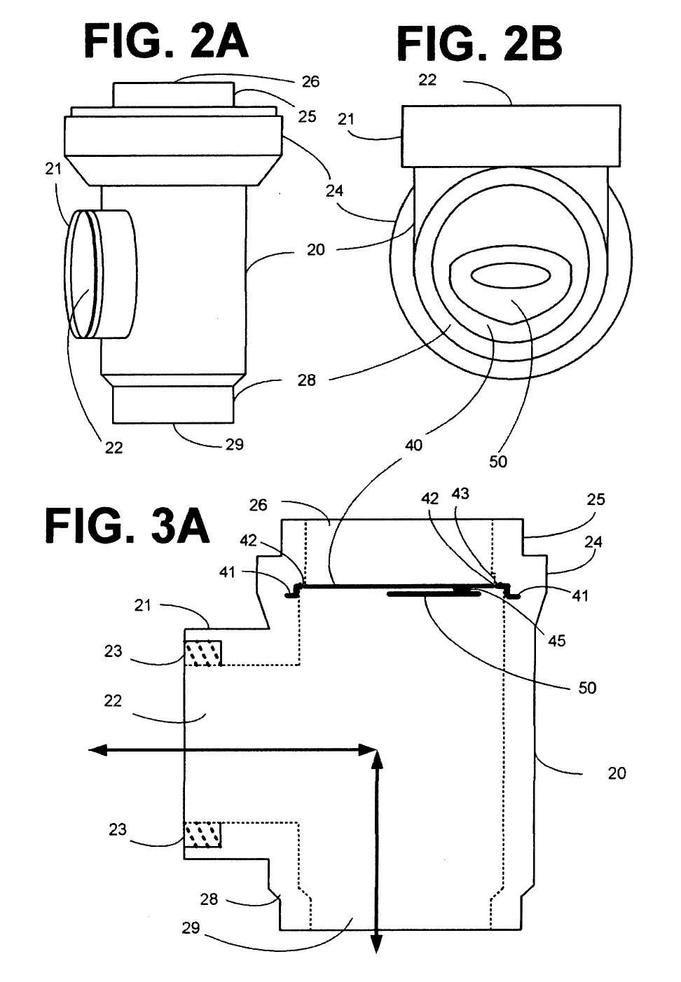

The test tee of the present invention utilizes a pull-tab pop top to create blockage for testing purposes. As shown in FIG. 2A, an example of the test tee of the present invention is illustrated a perspective view. In one embodiment, a street by street fitting is illustrated, however, it is understood that a hub by hub fitting could also be utilized. As shown, test tee 20 of the present invention includes cleanout or testing hub fitting 21 with threaded opening 22 into a fitting in the test tee 20 of the present invention. In an alternative embodiment, the threaded opening 22 could be a slip joint or solvent weld hub. Other openings 26 and 29 are also illustrated with hub fittings 24 and 28, respectively, on the test tee 20 of the present invention. Support member 25 comprises the pop top hub (not shown).

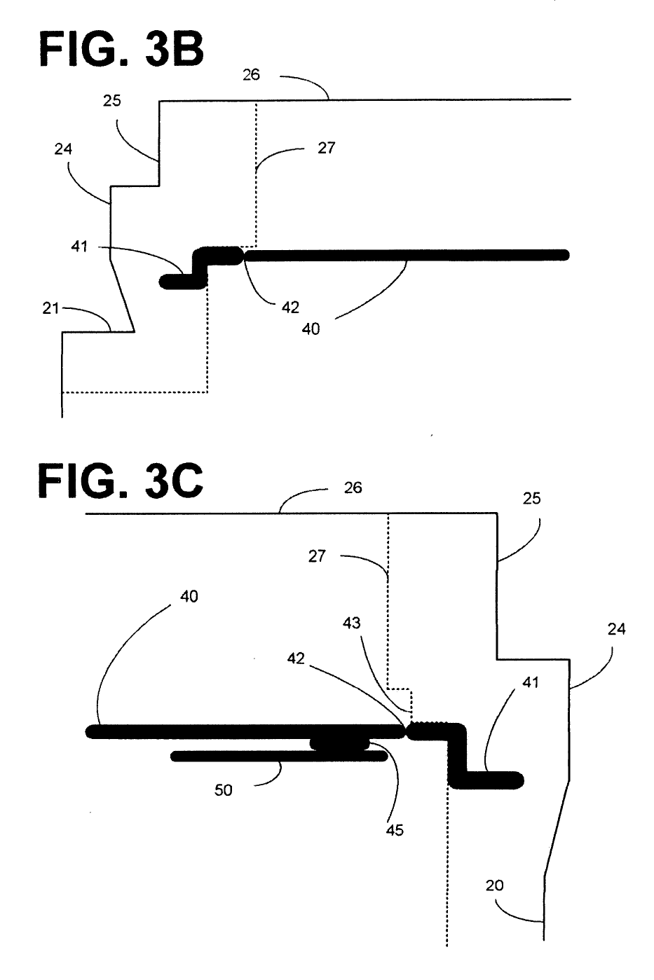

The pop top 40 impedes the flow of air or water through the opening 26. This is better illustrated in FIG. 3A. FIG. 3A is a cross-sectional side view illustrating an example of the test tee 20 of the present invention, with the pull-tab pop-top hub 40 and pull-tab 50 as shown in FIG. 2B. The pop top 40 is located perpendicular to the flow of either air or water through opening 26. FIG. 3A also shows an exemplary embodiment of the test tee 20 comprising openings 26 and 29 illustrated with hub fittings 24 and 28, respectively, and threaded opening 22 in testing hub fitting 21, opening 22 including internal threads 23. Support member 25 is shown with pop top 40. Pop top 40 further comprises pivot 45 and pull-tab 50. Pop top 40 meets anchors 41 at a breakpoints 42. The diameter of breakpoint 42 for pop top 40 is shown larger than the inside diameter of hub fitting 24. FIG. 3A also illustrates notched section 43.

As can be seen in the view of pop top 40 represented in FIGS. 3B and 3C, pop top 40 has a diameter larger than the inside diameter of hub fitting 24, in that the diameter of pop top 40 extends beyond the inner wall 27 of hub fitting 25. As illustrated by FIG. 3B, the pop top 40 meets anchor 41 at a breakpoint 42. The diameter of breakpoint 42 for pop top 40 is shown larger than the inside diameter of hub fitting 24. Also shown in FIG. 3B is opening 26 and testing hub fitting 21.

In an exemplary embodiment, the pop top 40 is stamped or molded with anchors 41, as illustrated in exemplary FIGS. 3A, 3B, and 3C. In order to prevent damage to test tee 20, anchors 41 are utilized with the pop top 40 to anchor the pop top 40 to the test tee 20. Support member 25, seated in hub fitting 24 in test tee 20, provides the support for anchors 41 so that the pop top 40 may be removed without damage to test tee 20. In one embodiment, anchors 41 utilized the same metallic material of the pop top 40. However, is understood that other materials may be utilized.

FIG. 3C shows an exemplary embodiment of pop top 40 with a pull-tab 50 to enable a person to remove the pop top 40 from the test tee 20 as required. In one embodiment, the pull-tab 50 is made of the same metallic material as pop top 40. However, it is understood that other materials may be utilized. The pull-tab 50 is attached to the pop top 40 utilizing some attaching means. The attaching means include, but are not limited to, spot welds, rivets, stamping, adhesives or the like. In one embodiment, a rivet is utilized to attach the pull-tab 50 to pop top 40. In another embodiment, pivot 45 is utilized with pull-tab 50, in order to assist in the removal of the pop top 40. Also illustrated by FIG. 3C, the pop top 40 meets anchor 41 at a breakpoint 42, the diameter of breakpoint 42 being larger than the inside diameter of hub fitting 24, thereby illustrating that the diameter of pop top 40 extends beyond the inner wall 27 of support member 25 seated in hub fitting 24.

In another embodiment, optional breakpoints 42 are molded into the pop top 40 to assist a person in removing the pop top from the test tee 20. FIG. 3C also illustrates an exemplary embodiment of one end of pop top 40 with the pull-tab 50 with breakpoint 42. In another embodiment, hub fitting 24 contains a notched section 43, wherein the notched section allows for the lip of pop top 40 to bend at least one breakpoint 42 into the notched section 43 when the pull-tab 50 is pulled away from pop top 40, allowing for the removal of pop top 40.

After pop top 40 is constructed, then the test tee 20 is constructed around pop top 40. In the preferred embodiment, the test tee 20 is constructed utilizing injection molding techniques.

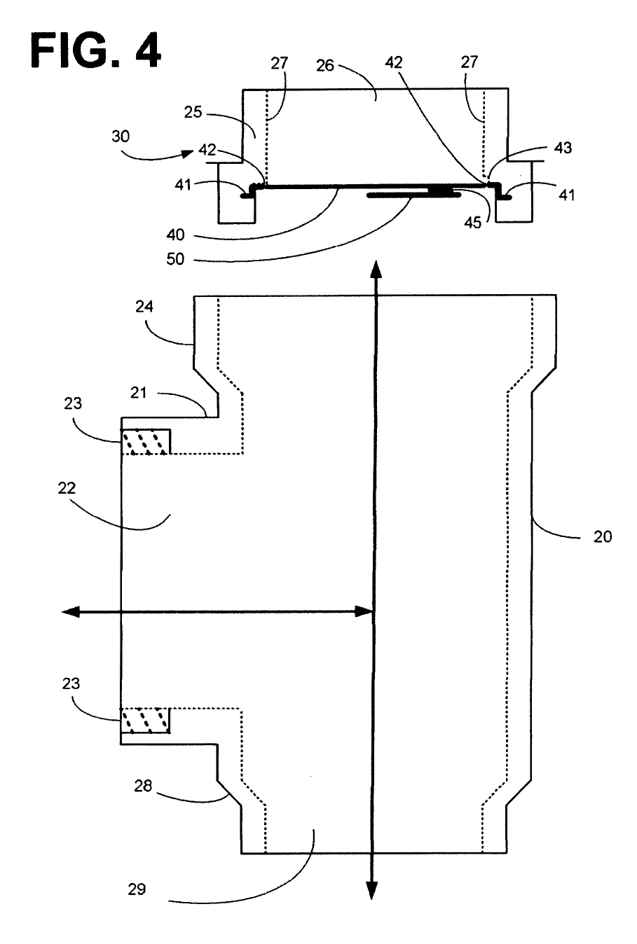

Shown in FIG. 4 is a cross-sectional side view of the pop top hub 30 before it is attached to the test tee 20 of the present invention, as shown in FIGS. 2B and 3A. The pop top hub 30 includes opening 26 and pop top 40. Pop top 40 is attached by pivot 45 to pull-tab 50 of the present invention. FIG. 4 illustrates pop-top hub 40 connected to anchors 41 connected to support member 25. Notched section 43 allows for the lip of pop top 40 to bend at least one breakpoint 42 into the notched section 43 when the pull-tab 50 is pulled away from pop top 40, allowing for the removal of pop top 40.

In another embodiment, the pop top 40 is molded into a polyvinyl chloride (PVC) pop top hub 30 using injection molding techniques. The pop top hub 30 can be constructed from other types of materials such as but not limited to galvanized pipe, cast iron, copper, ABS plastic or the like. Pop top 40 and anchors 41 are generally stamped from a metallic material that is then attached to pull-tab 50. However, it is understood that the pop top 40 is a breakaway insert and could be made with another types of breakaway material, including, but not limited to plastics, rubbers, and malleable metals. These plastics, rubbers and malleable metals include but are not limited to ABS, PVC, other plastics, aluminum, tin, copper, steel, rubber or other known plumbing materials.

After construction of pop top hub 30, the pop top hub 30 is then inserted into hub fitting 24 (FIG. 4) and attached to test tee 20. As further shown in exemplary embodiment FIG. 4, test tee 20 includes testing hub fittings 21 and 28 corresponding to openings 22 and 29, respectively. Opening 22 further includes internal threads 23. The attaching means include, but are not limited to, plastic adhesive, annealing, welding or other like bonding agent. At this time, the test tee 20 with pop top 40 is then ready for installation and usage as described above.

In an alternative embodiment, the test tee 20 (FIGS. 3A, 4, 5A, 6A) by itself without the pop top hub 30 (FIG. 4) is a unique and very marketable product. The test tee 20 on the present invention features a larger threaded opening 22 than the existing tee design. The threaded opening 22 is larger than the opening 12 on the prior art test tee 10 by at least ¼ inch to 1 inch, and preferably by ½ inch. The threaded opening 22 includes internal threads 23 that can be engaged by a threaded plug (not shown). The threaded plug (not shown) can be removed from threaded opening 22 to allow for removal of the pop top, and/or replaced once pressure testing is complete. The diameter of the interior center portion of the test tee 20 is also ½ larger which allows greater accessibility for drain cleaning equipment when the test tee 20 is used for a cleanout. The enlarged portions of the test tee 20 transitions back to the inside pipe dimension at the outlet in a smooth, unobtrusive to flow. The interior center portion of the test tee 20 is larger than the interior center portion of the prior art test tee 10 by at least ¼ inch to 1 inch, and preferably by ½ inch.

In the example illustrated, the test tee 20 is shown as street by street tee type plumbing fitting. It should be understood that the same characteristics could be implemented in a hub by hub or street by hub type tee fittings.

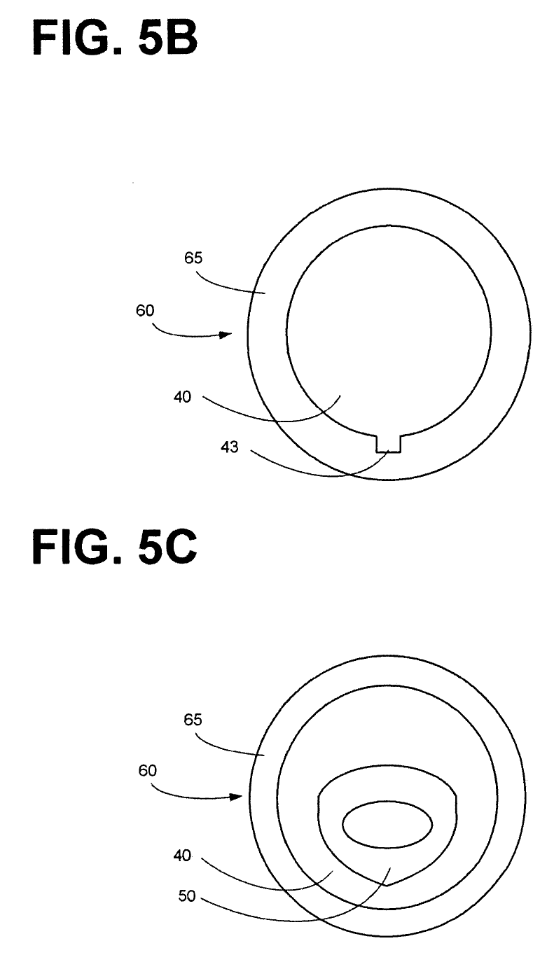

FIG. 5A is a cross-sectional side view illustrating an example of an alternative embodiment of the pop top hub 60 of the present invention, with the test tee 10 including with hub fittings 14 and 18 corresponding to openings 16 and 19, respectively. Test tee 10 features hub fitting 11 with threaded opening 22 that includes internal threads 13 that can be engaged by a threaded plug (not shown). In this embodiment, the pop top hub 60 is configured to fit within a hub fitting 14 of a test tee 10 fitting in the prior art. This is done to utilize the pop top 40 of the present invention in prior art test tees 10. In this view, pop top 40 is shown within pop top hub 60, wherein pop top hub 60 includes a notched section 43 cut away from support member 65. The embodiment in FIG. 5A shows pull-tab 50 attached to pop top 40 in operative communication with support member 65, wherein the diameter of pop top 40 extends into support member 65 (not shown). An exemplary embodiment of a pull-tab 50 with breakpoint 42 is shown, although the size and style of pull-tab may vary as needed according to the particular application.

The thickness of the pop top hub 60 is significantly reduced from the pop top hub 30 example described with regard to FIG. 4. The thickness of pop top hub 60 is significantly reduced, so it may fit within the hub fitting 14 of test tee 10 of the prior art. After the pop top hub 60 is inserted and attached to test tee 10, then a pipe 9 may be inserted in test tee 10, thereby compressing the pop top hub 60 between test tee 10 and the newly inserted pipe 9. The inside diameter of hub fitting 14 is larger than the diameter of pop top hub 60, and the diameter of pop top hub 60 is larger than the inside diameter of pipe 9. This allows for a smooth, unobtrusive flow from pipe 9 through pop top hub 60 and further through test tee 10. This alternative embodiment of FIG. 5A enables a person to utilize a test tee 10 of the prior art with the pop top hub 60 of the present invention.

As shown, pop top hub 60 includes many of the same components as described with regard to FIGS. 2B, 2C, 3A, 3B, 3C, and 4. The pop top hub 60 is manufactured utilizing the same techniques as described above.

FIG. 5B is a top view illustrating an exemplary embodiment of the pop top hub 60. In this view, pop top 40 is shown within pop top hub 60, wherein pop top hub 60 includes a notched section 43 cut away from support member 65. Although notched section 43 is shown as a particular size, the size of the notched section 43 should not be read to be limiting, since notched section 43 can vary in size as needed according to the particular application.

FIG. 5C is a bottom view illustrating an example of an alternative embodiment of the pop top hub 60 of the present invention. The embodiment in FIG. 5C shows pull-tab 50 attached to pop top 40 in operative communication with support member 65, wherein the diameter of pop top 40 extends into support member 65 (not shown). An exemplary embodiment of a pull-tab 50 is shown, although the size and style of pull-tab may vary as needed according to the particular application.

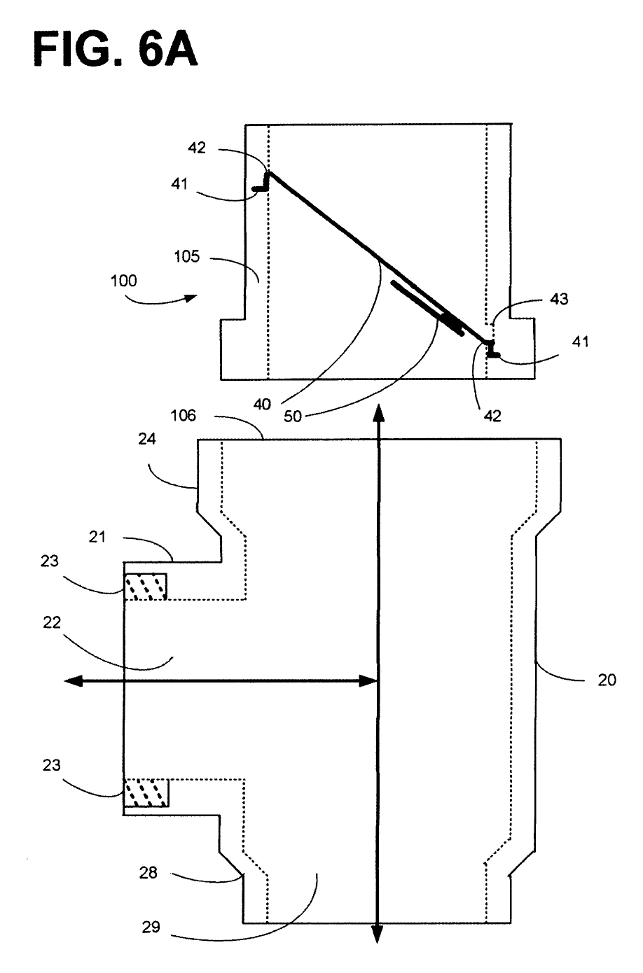

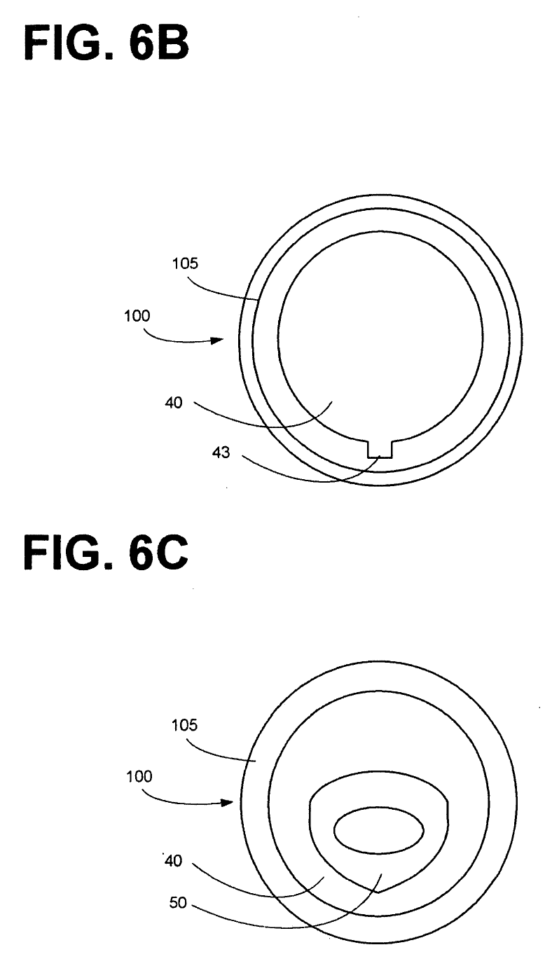

FIG. 6A is a cross-sectional side view illustrating an example of an alternative embodiment of the pop top 40, with the test tee 20 of the present invention. Pop top 40 is attached to anchors 41 at breakpoints 42. In this alternative embodiment, the pop top 40 is molded in to the pop top hub 100 at an angle 1° to 45°. In this embodiment, the pop top hub 100 is extended in order to accommodate the angle of the pop top 40. The pop top 40 is molded into pop top of 100 in order to make pull-tab 50 is more accessible to a person through threaded opening 22. Pop top hub 100 further includes support member 105, support member 105 further comprising a notched section 43. In this alternative embodiment, the angle is approximately 45°, however, it is understood that angles between zero to 45° may be utilized. Test tee 20 includes hub fittings 24 and 28 corresponding to openings 106 and 29, respectively. Opening 22 corresponds to testing hub fitting 21 and further includes internal threads 23. The attaching means for attaching pop top hub 100 with test tee 20 include, but are not limited to, plastic adhesive, annealing, welding or other like bonding agent. At this time, the test tee 20 with pop top 40 is then ready for installation and usage as described above.

FIG. 6B is a top view illustrating an example of an alternative embodiment of the pull tab pop top 100. The embodiment in FIG. 6B shows pop top 40 in operative communication with support member 105, wherein the diameter of pop top 40 extends into support member 105 (not shown). In this view, pop top 40 is shown within pop top hub 100, wherein pop top hub 100 includes a notched section 43 cut away from support member 105. Although notched section 43 is shown as a particular size, the size of the notched section 43 should not be read to be limiting, since notched section 43 can vary in size as needed according to the particular application.

FIG. 6C is a bottom view illustrating an example of an alternative embodiment of the pop top hub 100 of the present invention. The embodiment in FIG. 6C shows pull-tab 50 attached to pop top 40 in operative communication with support member 105, wherein the diameter of pop top 40 extends into support member 105 (not shown). An exemplary embodiment of a pull-tab 50 is shown, although the size and style of pull-tab may vary as needed according to the particular application.

In an alternative embodiment, the test tee of the present invention utilizes a removable threaded blockage device to create blockage for test purposes in the test tee. The removable threaded blockage device includes a threaded collar for engaging the internal threads of either or both of the internal first and second opposing openings that are axially aligned with each other in the test tee.

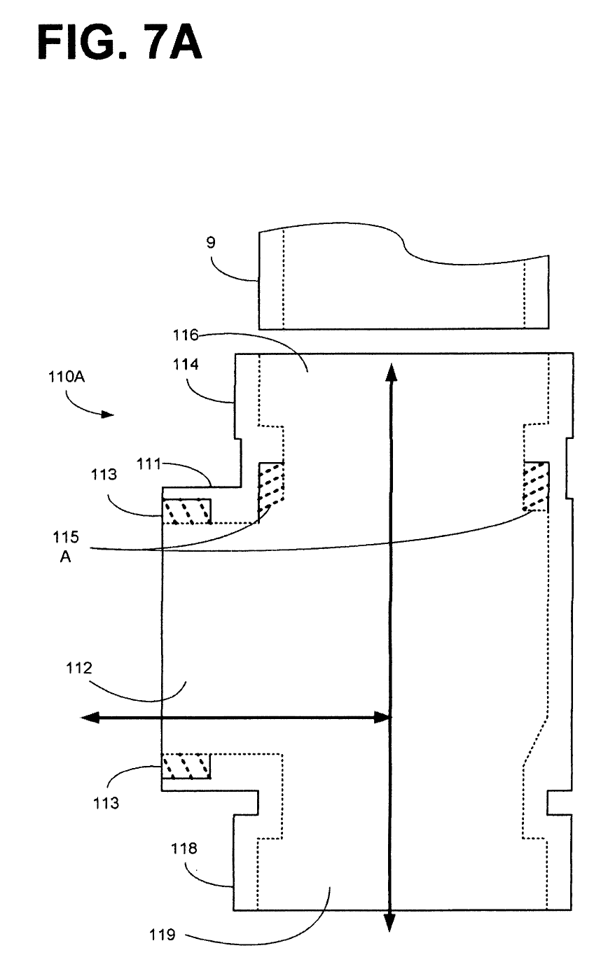

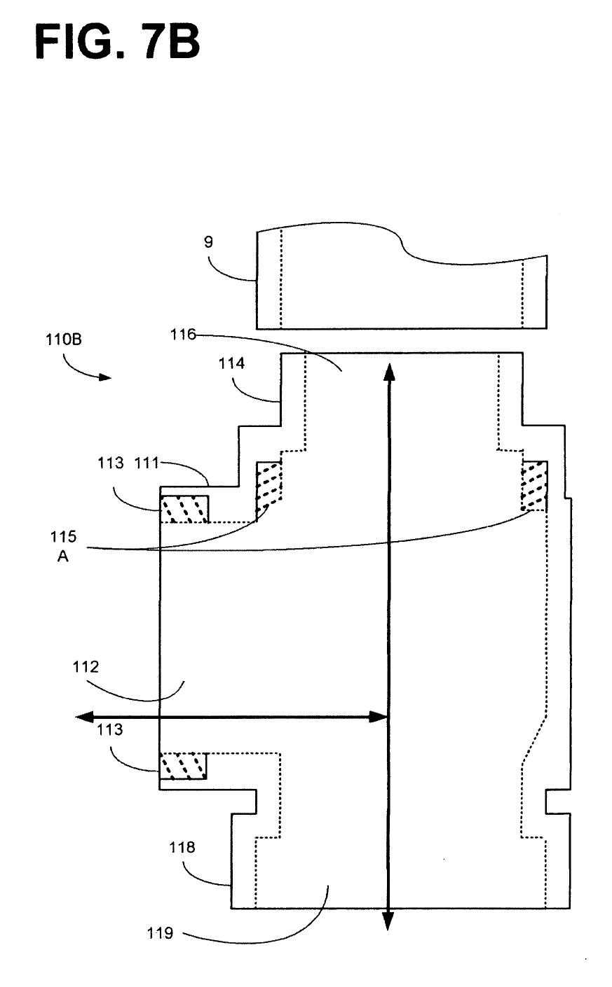

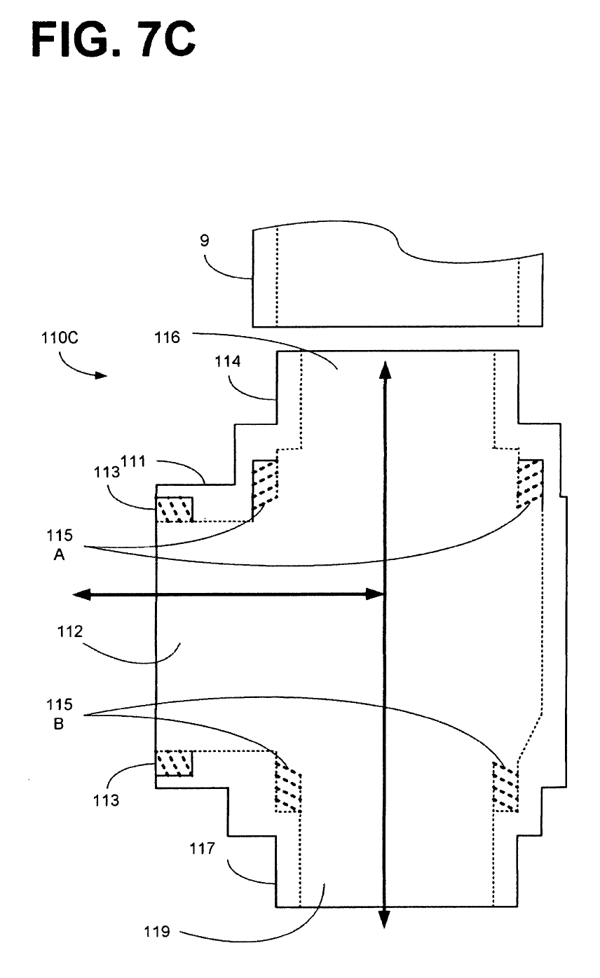

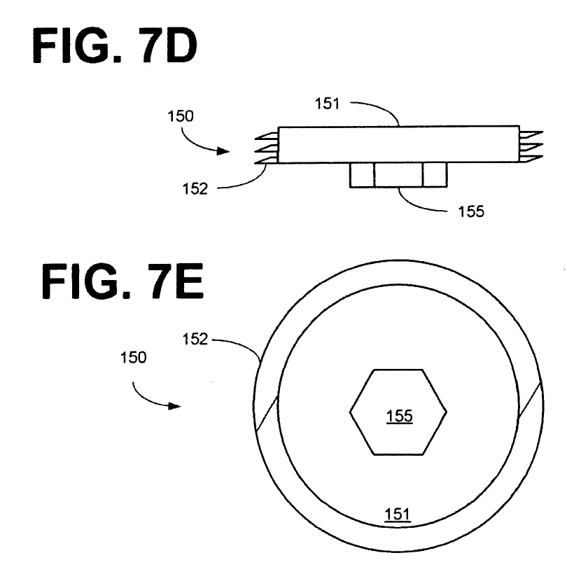

FIG. 7A is a cross-sectional side view illustrating an example of an alternative embodiment of the hub to hub test tee with of the present invention, with internal threads on one of the opposing openings that are axially aligned with each other. In this alternative embodiment, FIG. 7 (A-C) illustrates an example of the basic components of a test tee 110 fitting of the present invention. Shown is the test tee 110 fitting (A-C), which is simply a T-shaped fitting with a threaded opening 112 for a removable plug (not shown). Test tee fitting 110 has hub fittings (i.e. connectors) 114 and 118. Test tee fitting 110 also includes the clean out or testing hub fitting 111 that enables testing equipment or drain cleaning equipment to be inserted through the opening 112. The opening 112 connects openings 116 and 119 in the test tee fitting 110.

Opening 112 of test tee fitting 110(A-C) also includes internal threads 113 that can be engaged by a threaded plug (not shown). The threaded plug (not shown) can be removed from opening 112 to allow for removal of a removable threaded blockage device (FIG. 7D), and can replaced once pressure testing is complete. Accordingly, the test tee 110(A-C) on the present invention features a ¼ inch to 1 inch larger threaded opening 112 than the existing tee design to allow for removal of the threaded blockage device (FIG. 7D). The diameter of the interior center portion of the test tee 110 is also ¼ inch to 1 inch larger which allows greater accessibility for drain cleaning equipment when the test tee 110(A-C) is used for a cleanout. It is understood by the inventor that the interior center portion of test tee fitting 110 may be ¼ to 1 inch larger and openings 112 may be larger than 1 inch. Preferably, the enlarged portions of the test tee 110(A-C) transitions back to the inside pipe dimension at the outlet in a smooth, unobtrusive to flow.

The alternative embodiment of the test tee of the present invention utilizes a removable threaded blockage device (FIG. 7D) to create blockage for testing purposes. As shown in FIG. 7A, an example of the test tee 110A of the present invention with pipe 9 is illustrated a perspective view. In the alternative embodiment, a hub by hub fitting is illustrated, however, it is understood that a street by street or hub by street fitting could also be utilized, as shown in FIGS. 7B and 7C. As shown, test tee 110A of the present invention includes an internal threaded portion 115A. The internal threaded portion 115A enables a removable threaded blockage device 150 (FIG. 7D) to engage the internal threads 115A in the test tee 110A in order to create blockage on one side of the plumbing system.

FIG. 7B is a cross-sectional side view illustrating an example of an alternative embodiment of the hub to street test tee with of the present invention, with test tee 110B and pipe 9. FIG. 7B shows an embodiment of test tee 110B with internal threads 115A on one of the opposing openings that are axially aligned with each other. Test tee 110B has hub fittings 114 and 118 corresponding to openings 116 and 119, respectively. Hub fitting 111 corresponds to opening 112, which includes internal threads 113 to engage a threaded plug (not shown). As shown in FIG. 7B, hub fitting 114 (FIG. 7A) has been modified to illustrate a street connection. The street connection engages the internal diameter of pipe 9 to be affixed to test tee 110B.

FIG. 7C is a cross-sectional side view illustrating an example of an alternative embodiment of the street to street test tee 110C with of the present invention, with internal threads 115A and 115B on both of the opposing openings that are axially aligned with each other. Test tee 110C also includes hub fitting 111 which corresponds to threaded opening 112 and internal threads 113 to engage a threaded plug (not shown). In this an alternative embodiment enables a user to utilize a removable threaded blockage device 150 (FIG. 7D) on both sides of the test tee 110C. It should be understood that the hub to hub and hub to street test tees 110 could also utilize the dual internal threads on both of the opposing openings 116 and 119 that correspond to hub fittings 114 and 117, respectively, as shown here in FIG. 7C.

FIG. 7D is a cross-sectional side view illustrating an example of an alternative embodiment of the removable threaded blockage device 150 for a test tee 110(A-C) of the present invention. The removable threaded blockage device 150 includes circular base plate 151, threading 152 and wrench collar 155. Threading 152 enables the removal of the threaded blockage device 150 to engage the internal threads 115A or 115B of the test tee 110. Wrench collar 155 is illustrated as a hexagon shape, however, it could also be square or some other noncircular shape. The wrench collar 155 enables a user to apply force to tighten the engagement of the removable threaded blockage device 150 with the test tee 110 of the present invention.

In the alternative embodiment, the removable threaded blockage device 150 is molded into a polyvinyl chloride (PVC) using injection molding techniques. The removable threaded blockage device 150 can be constructed from other types of materials such as, but not limited to, galvanized pipe, cast iron, copper, ABS plastic, other plastics, aluminum, tin, copper, steel, rubber or other known plumbing materials.

FIG. 7E is a bottom view illustrating an example of an alternative embodiment of the removable threaded blockage device 150 for a test tee 110(A-C) of the present invention. The removable threaded blockage device 150 includes circular base plate 151, threading 152 and wrench collar 155. Threading 152 enables the removal of the threaded blockage device 150 to engage the internal threads 115A or 115B of the test tee 110. Wrench collar 155 is illustrated as a hexagon shape, however, it could also be square or some other noncircular shape. The wrench collar 155 enables a user to apply force to tighten the engagement of the removable threaded blockage device 150 with the test tee 110 of the present invention.

It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims that follow.

What is claimed is:

1. A test tee device for leak testing a pipe line system, comprising:
a tee fitting, said tee fitting comprising
a tubular section extending between a first and a second opposing openings axially aligned with each other;
a third opening communicating with the tubular section of the tee fitting;
a removable insert attached in said tubular section perpendicular to said first opening and blocking the flow through said first opening;
wherein said tubular section has a inside diameter greater than said first opening inside diameter and said the second opening inside diameter;
wherein said removable insert is larger than the inside diameter of said tubular section; and
wherein said tubular section contains a notched section.

2. The test tee device of claim 1, further comprising:
an anchor that attaches said removable insert into said tubular section.

3. The test tee device of claim 2, wherein said removable insert is composed of a breakaway material.

4. The test tee device of claim 3, wherein said pull-tab is attached to said removable insert using an attaching means.

5. The test tee device of claim 4, wherein said attaching means comprises a rivet.

6. The test tee device of claim 3, wherein said breakaway material is composed of a malleable metal.

7. The test tee device of claim 3, wherein said breakaway material is composed of a plastic.

8. The test tee device of claim 1, wherein said removable insert further comprises:
a pull-tab on said removable insert on a side opposite of said first opening.

9. The test tee device of claim 1, wherein said removable insert further comprises:
breakpoints to assist in removal of said removable insert.

10. A test tee device for leak testing a pipe line system, comprising:
a tee fitting, said tee fitting comprising
a tubular section extending between a first and a second opposing openings axially aligned with each other;
a third opening communicating with the tubular section of the tee fitting;
a removable insert attached in said tubular section perpendicular to said first opening and blocking the flow through said first opening;
wherein said tubular section has a inside diameter greater than said first opening inside diameter and said the second opening inside diameter;
wherein said removable insert is larger than the inside diameter of said tubular section; and
wherein said removable insert comprises a threaded blockage device.

11. A method for testing a plumbing system with a tee fitting comprising a tubular section extending between a first and a second opposing openings axially aligned with each other; a third opening communicating with the tubular section of the tee fitting and a removable insert attached in said tubular section perpendicular to said first opening and blocking the flow through said first opening, wherein said removable insert is larger than the inside diameter of said tubular section, and wherein said tubular section contains a notched section, the method comprising:
applying a test pressure to said test tee fitting through one of said opposing openings; and
removing said removable insert if said test pressure is maintained for a predetermined time;
wherein removal of removable insert is engaged by a pull tab pressing a portion of the removable insert into the notched section.

12. A method for testing a plumbing system with a tee fitting comprising a tubular section extending between a first and a second opposing openings axially aligned with each other; a third opening communicating with the tubular section of the tee fitting and a removable insert attached in said tubular section perpendicular to said first opening and blocking the flow through said first opening, wherein said removable insert is larger than the inside diameter of said tubular section, the method comprising:
applying a test pressure to said test tee fitting through one of said opposing openings; and
removing said removable insert if said test pressure is maintained for a predetermined time;
wherein removing a removable insert comprises engaging a threaded blockage device.

13. A method for manufacturing a test tee, the method comprising:
molding a test tee fitting, said tee fitting comprising a tubular section extending between a first and a second opposing openings axially aligned with each other; a third opening communicating with the tubular section of the tee fitting; and
attaching a removable insert into said tubular section perpendicular to said first opening and blocking the flow through said first opening, wherein said removable insert is anchored to said tubular section, wherein said removable insert is larger than the inside diameter of said tubular section, and wherein said tubular section contains a notched section.

14. A method for manufacturing a test tee, the method comprising:
molding a test tee fitting, said tee fitting comprising a tubular section extending between a first and a second opposing openings axially aligned with each other; a third opening communicating with the tubular section of the tee fitting; and
attaching a removable insert into said tubular section perpendicular to said first opening and blocking the flow through said first opening, wherein said removable insert is anchored to said tubular section, wherein said removable insert is larger than the inside diameter of said tubular section, and wherein said removable insert comprises a threaded blockage device.
